(19) United States
(12) Patent Application Publication
(10) Pub. No.: US 2013/0111762 A1
(43) Pub. Date: May 9, 2013

(54) RECIPROCATING ELECTRIC SHAVER

(71) Applicants: Fumio Taniguchi, Shiga (JP); Yoichi Takaoka, Shiga (JP); Yasuo Ibuki, Shiga (JP); Yasunori Ueda, Shiga (JP)

(72) Inventors: Fumio Taniguchi, Shiga (JP); Yoichi Takaoka, Shiga (JP); Yasuo Ibuki, Shiga (JP); Yasunori Ueda, Shiga (JP)

(73) Assignee: PANASONIC CORPORATION, Kadoma-shi, Osaka (JP)

(21) Appl. No.: 13/808,067

(22) PCT Filed: Jun. 13, 2011
(86) PCT No.: PCT/JP2011/063456

§ 371 Date: Jan. 2, 2013

(30) Foreign Application Priority Data
Jul. 8, 2010 (JP) 2010-156145

(51) Int. Cl. B26B 19/28

(52) U.S. Cl. CPC B26B 19/28
USPC 30/42

(57) ABSTRACT

A reciprocating electric shaver includes: a rotary motor 110; a conversion mechanism converting rotating motion of the rotary motor 110 to reciprocating motion; and a pair of driving elements coupled to the conversion mechanism and reciprocating in phases opposite to each other. Each of the driving elements drives a plurality of blades. In each of the driving elements, an inner blade attachment portion to which an inner blade 54 is detachably attached is formed, and moreover, an elastic leg 133 or 143 supporting the inner blade attachment portion to allow the same to reciprocate is formed, an urging member urging the inner blade in a detaching direction of the inner blade is provided in each inner blade attachment portion, and in a case of being viewed in a reciprocating direction of the driving elements, an intermediate line D of the elastic leg 133 or 143 in a direction orthogonal to the reciprocating direction and the detaching direction is located between a rotation axis C of the rotary motor 110 and a line E of action of reaction force produced by the urging member.

### TECHNICAL FIELD

The present invention relates to a reciprocating electric shaver.

### BACKGROUND ART

One of conventionally known reciprocating electric shavers, as disclosed in Patent Literature 1, is provided with a conversion mechanism configured to convert rotating motion of a rotary motor to reciprocating motion, and the conversion mechanism reciprocates a driving element to which an internal blade is attached. Moreover, under the driving element, a balancer is provided to reciprocate at a phase 180 degrees different from that of the driving element.

In Patent Literature 1, the balancer is reciprocated in phase opposite to the driving element to reduce vibration of the driving element in the reciprocating direction.

In the case where two driving elements to which internal blades are attached are arranged side by side, vibration of the driving elements in the reciprocating direction can be reduced by reciprocating the driving elements in phases opposite to each other.

### CITATION LIST

### Patent Literature

Patent Literature 1: Japanese Patent Laid-open Publication No. 2004-016524

### SUMMARY OF INVENTION

However, if the two driving elements are reciprocated in opposite phases to each other like the aforementioned conventional technique, moments about the rotational axis of the rotary motor at the driving elements are directed in a same rotational direction. This causes great vibration during operation of the reciprocating electric shaver.

In order to solve this problem, it is conceived to adjust a balance so as to bring gravity centers of the driving elements close to the rotating shaft of the rotary motor, and to thereby reduce the vibrations in the rotation direction. However, if the balance is adjusted as described above, then a load to be applied on elastic legs of the driving elements is increased.

In this connection, an object of the present invention is to obtain a reciprocating electric shaver capable of suppressing the increase of the load to the elastic legs.

The present invention is a reciprocating electric shaver, including: a rotary motor; a conversion mechanism converting rotating motion of the rotary motor to reciprocating motion; and a pair of driving elements coupled to the conversion mechanism and reciprocating in phases opposite to each other, in which each of the driving elements drives a plurality of blades, in each of the driving elements, an inner blade attachment portion to which an inner blade is detachably attached is formed, and moreover, an elastic leg supporting the inner blade attachment portion to allow the same to reciprocate is formed, an urging member urging the inner blade in a detaching direction of the inner blade is provided in each inner blade attachment portion, and in a case of being viewed in a reciprocating direction of the driving elements, an intermediate line of the elastic leg in a direction orthogonal to the reciprocating direction and the detaching direction is located between a rotation axis of the rotary motor and a line of action of reaction force produced by the urging member.

In accordance with the present invention, in the case of being viewed in the reciprocating direction of the driving elements, the intermediate line of the elastic leg in the direction orthogonal to the reciprocating direction and the detaching direction is located between the rotation axis of the rotary motor and the line of action of the reaction force produced by the urging member. Therefore, the stresses in the twisting direction, which are generated in the elastic legs, are reduced, and the reciprocating electric shaver capable of suppressing the increase of the load to the elastic legs can be obtained.

### BRIEF DESCRIPTION OF THE DRAWINGS

FIGS. 1(a) to 1(c) are views showing a reciprocating electric shaver according to an embodiment of the present invention, FIG. 1(a) being a front view thereof, FIG. 1(b) being a side view, and FIG. 1(c) being a back view.

FIG. 2 is an exploded perspective view showing a head section according to the embodiment of the present invention.

FIG. 3 is an exploded perspective view showing a blade flame section according to the embodiment of the present invention.

FIG. 4 is a perspective view of the head section according to the embodiment of the present invention.

FIG. 5 is a cross-sectional view of the head section according to the embodiment of the present invention.

FIG. 6 is a sectional side view of the head section according to the embodiment of the present invention.

FIG. 7 is a perspective view of a driving mechanism according to the embodiment of the present invention.

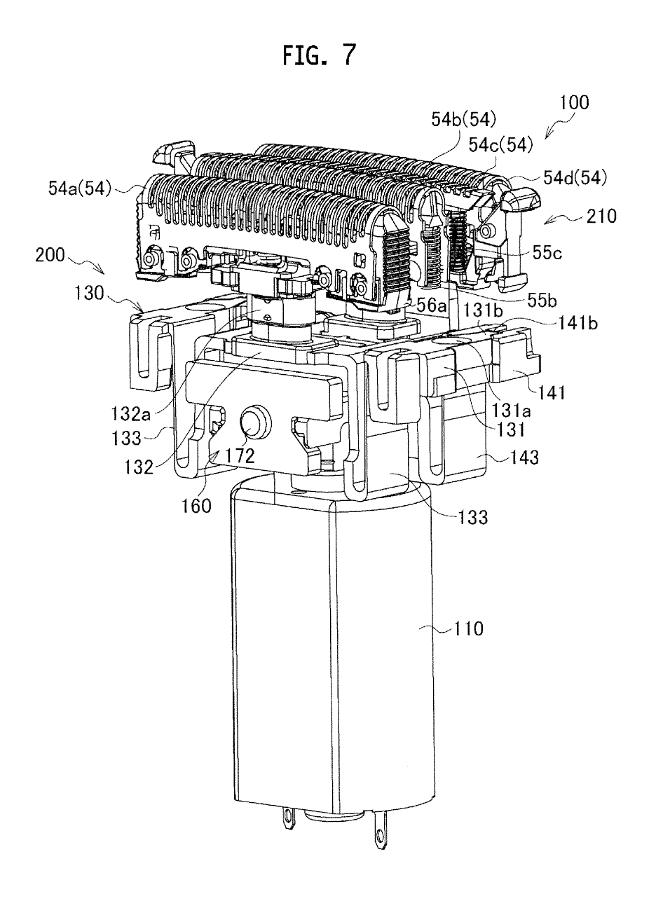

FIG. 8 is a perspective view of the driving mechanism according to the embodiment of the present invention when viewed in a direction opposite to that of FIG. 7.

FIG. 9 is a side view of the driving mechanism according to the embodiment of the present invention.

FIG. 10 is a sectional side view of the driving mechanism according to the embodiment of the present invention.

FIGS. 11(a) and 11(b) show the driving mechanism according to the embodiment of the present invention, FIG. 11(a) being a plan view thereof, FIG. 11(b) being a plan view schematically showing movement thereof during vibration.

FIG. 12 is an exploded perspective view showing driving elements and balance adjustment members according to the embodiment of the present invention.

FIG. 13 is an exploded perspective view of the driving elements and balance adjustment members according to the embodiment of the present invention when viewed in a direction opposite to FIG. 12.

FIGS. 14(a) and 14(b) are front and plan views, respectively, showing a first driving element according to the embodiment of the present invention.

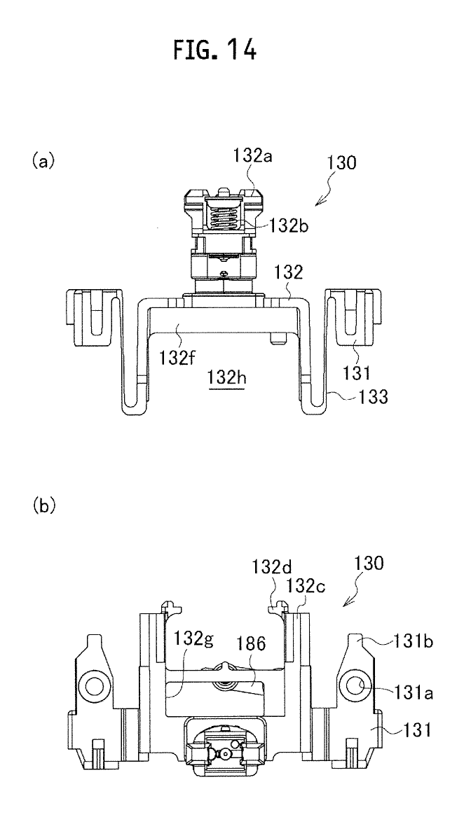

FIGS. 15(a) and 15(b) are front and plan views, respectively, showing a second driving element according to the embodiment of the present invention.

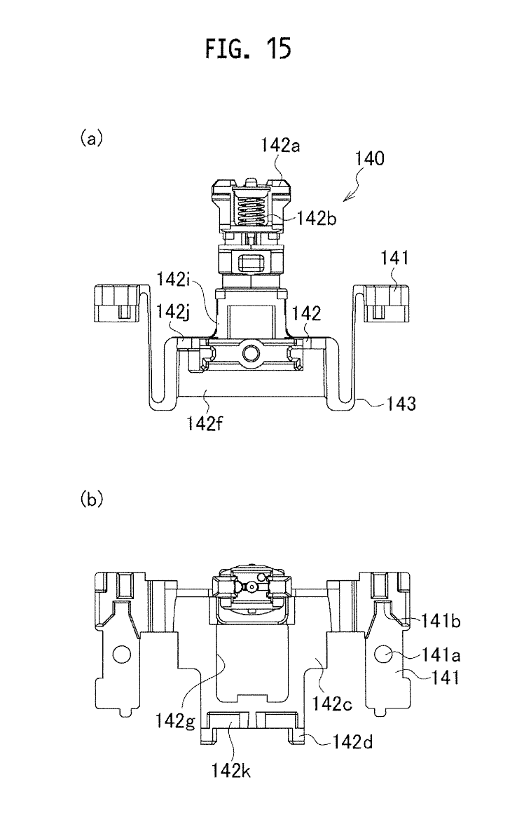

FIG. 16 is a side view showing a driving mechanism according to a first modification of the embodiment of the present invention.

FIG. 17 is a side view showing a driving mechanism according to a second modification of the embodiment of the present invention.

FIG. 18 is a perspective view showing a modification of the first driving element according to the embodiment of the present invention.

FIG. 19 is schematic views for explaining an influence by a rotation moment in a front-back direction X according to the embodiment of the present invention, FIG. 19(a) being a view viewed in a Z direction; FIG. 19(b) being a view viewed in a Y direction; and FIG. 19(c) being an explanatory view of a width of a leg.

### DESCRIPTION OF EMBODIMENTS

Hereinafter, an embodiment of the present invention will be described in detail with reference to the drawings. In the following description, the direction that a plurality of outer blades are arranged side by side is referred to as a front-back direction (shaving direction) X; the direction that the outer blades extend is referred to as a right-left direction Y; and the vertical direction when the head section is placed with the outer blades facing upward is referred to as an up-down direction Z. The side of a reciprocating electric shaver where a switch portion is provided is referred to as a front side in the front-back direction X.

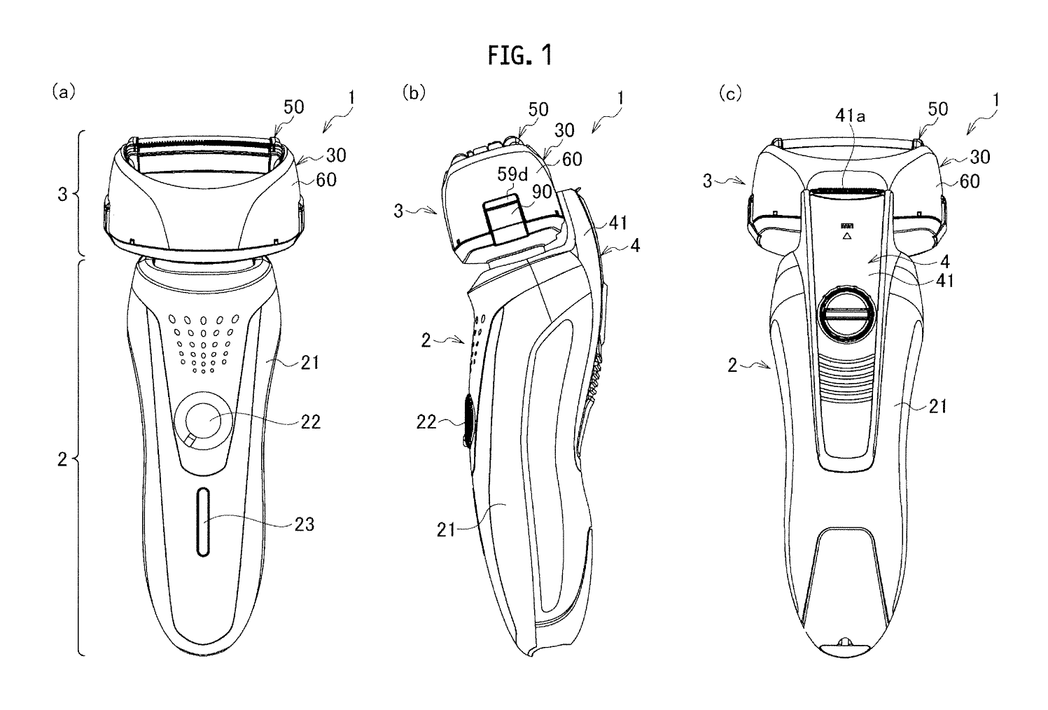

As shown in FIGS. 1(a) to 1(c), a reciprocating electric shaver 1 according to the embodiment includes a grip section 2 gripped by a hand and a head section 3 supported by the grip section 2.

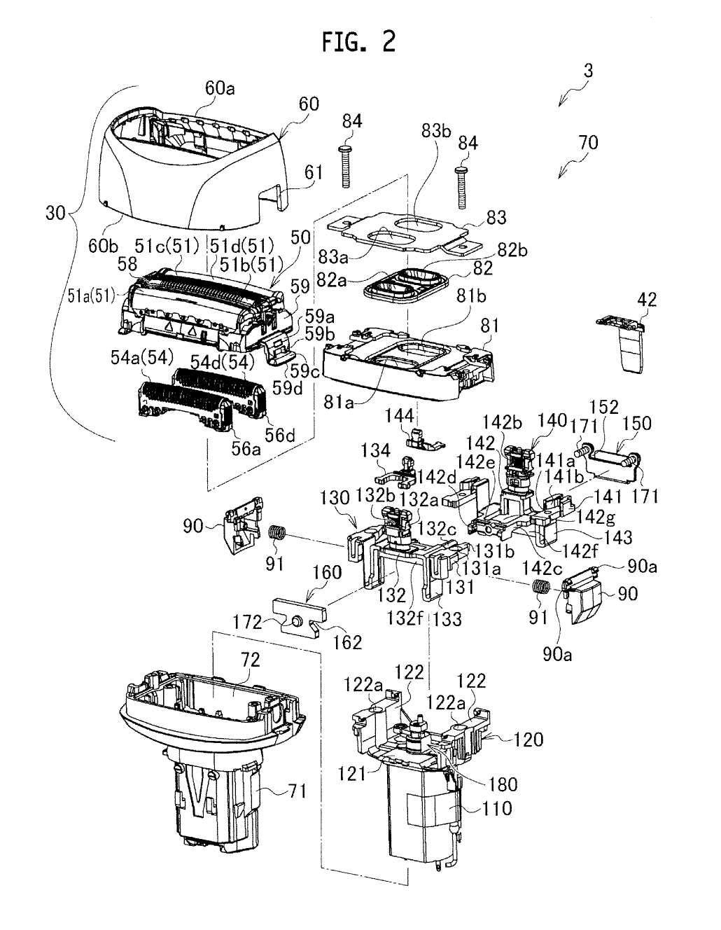

The grip section 2 includes a grip body 21 made of synthetic resin. As shown in FIG. 1(a), the grip body 21 is provided with a switch portion 22 and a display portion 23. The switch portion 22 turns on and off a rotary motor 110 (see FIG. 2). The display portion 23 displays a charge state of a not-shown battery incorporated in the grip body 21. In the reciprocating electric shaver 1 according to the embodiment, a trimmer unit 4 is formed. As shown in FIG. 1(c), a trimmer handle 41 is attached in the back side (rear side) of the grip body 21 so as to slide in the up-down direction. At an upper end of the trimmer handle 41, a trimmer blade 41a is formed.

Inner blades 54 provided within the outer blades 51 (under the outer blades 51) exposed above the head section 3 are moved relatively to the outer blades 51 (reciprocated in the right-left direction Y) to cut body hair inserted in blade holes of the outer blades in conjunction with the outer blades 51.

Hereinafter, the configuration of the head section 3 is described.

As shown in FIG. 2, the head section 3 includes a head section body 70 attached to the grip body 21 and a blade flame unit 30 detachably attached to the head section body 70.

In this embodiment, a later-described driving mechanism 100 is accommodated in a driving mechanism accommodation portion 72 formed in a head case 71 opened upward. Moreover, a head case cover 81 is placed over the upper opening portion of the head case 71 with the driving mechanism 100 accommodated in the driving mechanism accommodation portion 72 and is fixed by screws 84 with a driving element water-proof rubber 82 and a rubber holding plate 83 interposed therebetween, thus forming the head section body 70.

At this time, the driving mechanism accommodation portion 72 accommodates portions of the driving mechanism 100 other than attachment portions to which the inner blades 54 are attached. In this embodiment, the attachment portions include inner blade attachment portions 132a and 142a of the first and second driving elements 130 and 140 and driving rods 134 and 144 attached to the inner blade attachment portions 132a and 142a. In other words, only the attachment portions out of the driving mechanism 100 to which the inner blades 54 are attached are exposed above the head section body 70.

To be specific, first, the head case cover 81 is put on the upper opening portion of the head case 71 in such a manner that the inner blade attachment portions 132a and 142a of the first and second driving elements 130 and 140 are respectively inserted into through-holes 81a and 81b formed in the head case cover 81 to be exposed above the head case cover 81.

Next, the inner blade attachment portions 132a and 142a exposed above are respectively inserted into through-holes 82a and 82b formed in the driving element water-proof rubber 82 to be exposed above the driving element water-proof rubber 82. At this time, neck portions of the inner blade attachment portions 132a and 142a are tightened by the driving element water-proof rubber 82 to seal internal space of the driving mechanism accommodation portion 72.

The inner blade attachment portions 132a and 142a exposed above the driving element water-proof rubber 82 are respectively inserted into the through-holes 83a and 83b formed in the rubber holding plate 83 to be exposed above the rubber holding plate 83. Simultaneously, the inner blade attachment portions 132a and 142a exposed above the rubber holding plate 83 are attached to the driving rods 134 and 144, respectively. The driving mechanism 100 is thus accommodated in the driving mechanism accommodation portion 72 in a state where the attachment portions for attachment of the inner blades 54 are exposed above the head section body 70.

As described above, in this embodiment, the head case 71, head case cover 81, driving element water-proof rubber 82, and rubber holding plate 83 constitute a substantially box-shaped water-proof space (sealed space) 80. It is therefore prevented that body hair cut by the inner blades 54 or water used to wash the inner blades 54 or the like enters in the water-proof space 80 accommodating the rotary motor 110 and the like.

As shown in FIG. 2, the blade flame unit 30 includes a box-shaped outer blade cassette 50 and a cylindrical peripheral frame 60. The outer blade cassette 50 includes a plurality of outer blades 51 which are movable in the up-down direction. The peripheral frame 60 is attached so as to accommodate the outer blade cassette 50 from below and cover the entire outer blade frame 59 of the outer blade cassette 50.

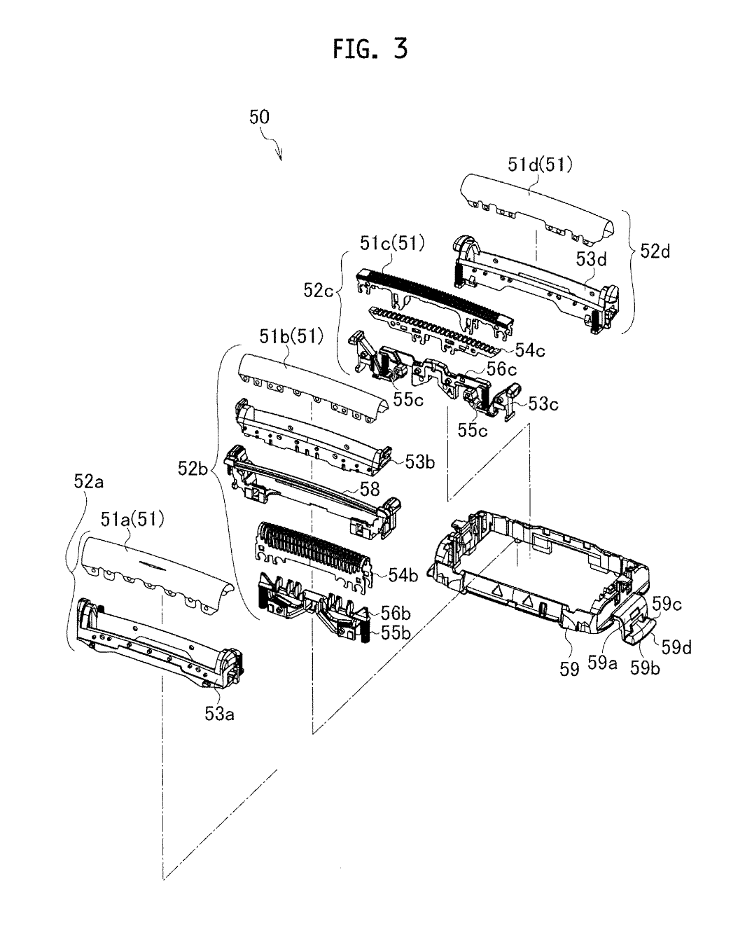

The outer blade cassette 50 includes a plurality of outer blades 51 arranged side by side in the front-back direction X. This embodiment includes four outer blades 51 including a first net blade 51a, a finishing net blade 51b, a slit blade 51c, a second net blade 51d arranged side by side in the front-back direction X (see FIG. 3).

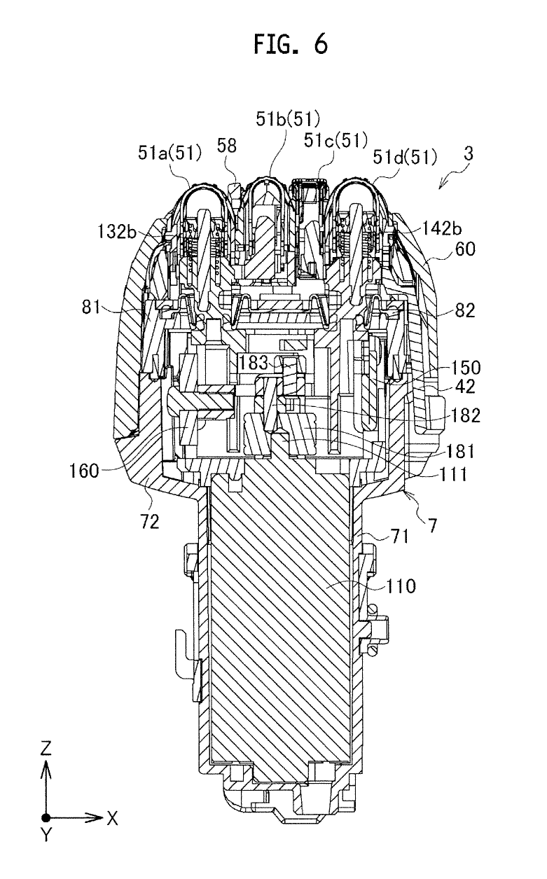

As shown in FIG. 6, each of the net blades 51a, 51b, and 51d is curved in an inverted U-shape along the front-back direction (in the short-side direction) X so as to convex upward when viewed from the side (when the outer blades are viewed in the right-left direction Y). Furthermore, each of the net blades 51a, 51b, and 51d is slightly curved in the left-right direction (in the longitudinal direction) Y so as to convex upward when viewed from the front (when the outer blades are viewed in the front-back direction X). In this embodiment, the net blades 51a, 51b, and 51d are curved so as to convex upward when viewed from the front but do not need to be curved.

In the net blades 51a, 51b, and 51d, a number of blade holes (not shown) are defined. In this embodiment, as shown in FIG. 6, the blade width of the finishing net blade 51b (width in the front-back direction X) is made smaller than the blade widths of the first and second net blades 51a and 51d. By making the blade width of the finishing net blade 51b smaller than the blade widths of the other net blades 51a and 51d (widths in the front-back direction X), that is, by making the curvature radius of the finishing net blade 51b smaller, skin pressed against the surface is greatly protruded inside through the blade holes, so that the finishing net blade 51b can cut body hair shorter.

As shown in FIG. 3, the slit blade 51c is curved in a squared U shape along the front-back direction (short-side direction) X and is provided with a plurality of slits (blade holes) extended from the flat upper wall to the side walls.

In other words, in the slit blade 51c, the number of slits (blade holes) are defined by bars provided from the flat upper wall to the side walls and bars extending at bottoms of the side walls in the longitudinal direction (right-left direction) Y.

The net blades 51a, 51b, and 51d constituting the outer blades 51 are attached to specialized outer blade flames 53a, 53b, and 53d to form outer blade units 52a, 52b, and 52d, respectively.

A skin guard member 58 is attached to the first net blade 51a side of the outer blade frame 53b. The slit blade 51c and skin guard member 58 sandwiching the finishing net blade 51b at the front and rear effectively prevent skin from being strongly pressed against the finishing net blade 51b having a small curvature radius.

The outer blade units 52a, 52b, 52c, and 52d are independently engaged with the outer blade frame 59 so as to move up and down, thus forming the outer blade cassette 50. This outer blade cassette 50 is detachably attached to the peripheral frame 60 and is detachably attached to the head section body 70.

The inner blades 54 are dedicatedly provided corresponding to the net blades 51a, 51b, and 51d and slit blade 51c constituting the outer blades 54. Specifically, under (inside) the net blades 51a, 51b, and 51d, inverted U-shaped inner blades 54a, 54b, and 54d along the curves of the net blades 51a, 51b, and 51d are provided, respectively (see FIGS. 2 and 3). Under (inside) the slit blade 51c, an inner slit blade 54c having a squared U-shape along the curve of the slit blade 51c is provided.

These inner blades 54a, 54b, and 54d and inner slit blade 54c are attached to the driving mechanism 100 (the inner blade attachment portions 132a and 142a and driving rods 134 and 144 of the first and second driving elements 130 and 140). When the driving mechanism 100 is driven, the inner blades 54a, 54b, and 54d and inner slit blade 54c are configured to individually reciprocate in the right-left direction (longitudinal direction) Y.

The inner blades 54a, 54b, and 54d and inner slit blade 54c provided under (inside) the net blades 51a, 51b, and 51d and slit blade 51c are respectively moved relatively to the net blades 54a, 54b, and 54d and inner slit blade 54c (reciprocated in the right-left direction Y) to cut body hair inserted in the blade holes of the net blades 51a, 51b, and 51d and the slits of the inner slit blade 54c in conjunction with the net blades 51a, 51b, and 51d and slit blade 51c.

In this embodiment, the finishing inner blade 54b attached to a base 56b is attached to the outer blade cassette 50 so as to reciprocate relatively to the finishing net blade 51b, and the inner slit blade 54c attached to a base 56c is attached to the outer blade cassette 50 so as to reciprocate relatively to the slit blade 51c (see FIG. 3).

To be specific, as shown in FIG. 3, outer blade frames 53c to which the slit blade 51c is attached are provided at both ends in the direction Y, and the base 56c is attached between the outer blade flames 53c with inner blade lifting springs 55c interposed therebetween so as to reciprocate in the direction Y. The inner slit blade 54c is attached to the base 56c, and the slit blade 51c is attached to the outer blade frames 53c over the inner slit blade 54c, thus forming the outer blade unit 52c.

The outer blade frame 53b attached to the finishing net blade 51b is attached to the skin guard member 58, and the finishing inner blade 54b attached to the base 56b is provided under the finishing net blade 51b and is energized by inner blade lifting springs 55b, thus forming the outer blade unit 52b (see FIG. 3).

As described above, in this embodiment, the outer blade cassette 50 is attached to the head section body 70 with the inner blades 54a and 54d respectively attached to the inner blade attachment portions 132a and 142a exposed above the head section body 70, and the driving rods 134 and 144 are respectively attached to the inner blade attachment portions 132a and 142a. The outer blade cassette 50 is attached to the head section body 70 so that the inner blades 54a and 54d are placed under the outer blade units 52a and 52d. When the outer blade cassette 50 is attached to the head section body 70, the bases 56b and 56c attached to the outer blade cassette 50 are coupled with the driving rods 134 and 144, respectively. In other words, by attaching the outer blade cassette 50 to the head section body 70, the finishing inner blade 54b and inner slit blade 54c can be operated in conjunction with the movement of the driving mechanism 100.

Moreover, as shown in FIG. 2, elastic pieces 59a are extended downward at both right and left sides of the outer blade frame 59 of the outer flame cassette 50. In the paired right and left elastic pieces, through-holes 59b penetrating in the right-left direction are individually formed. Furthermore, at the bottoms of the elastic pieces 59a, release buttons 59c are individually extended outward.

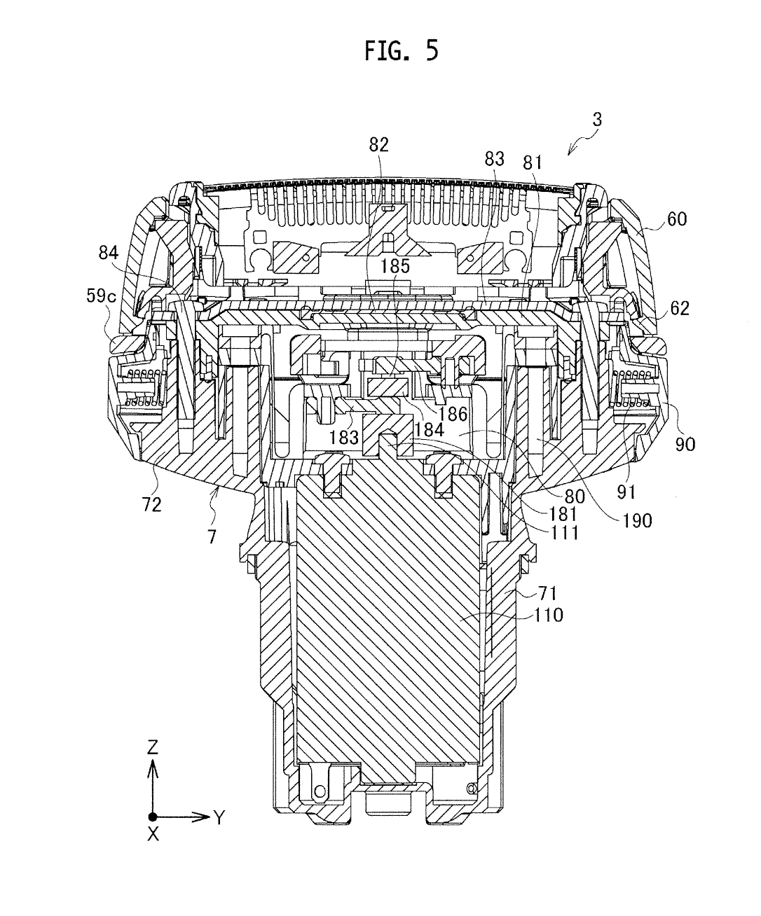

In the cylindrical outer frame 60 open at the top and bottom ends, recessed portions 61 are formed at both right and left sides of the bottom edge, and hooks 62 are individually protruded inward from the bottoms of the recessed portions 61 (see FIG. 5).

In this embodiment, in the outer frame 60, a top opening 60a is smaller than the profile of the outer blade frame 59 of the outer blade cassette 50 and larger than the profile of the entire blade faces of the outer blades 51. A lower opening 60b is larger than the profile of the outer blade frame 59 other than the release buttons 59c.

As the outer blade cassette 50 is inserted from the lower opening 60b into the outer frame 60 with the release buttons 59c at the both right and left ends being inserted into the recessed portions 61, the top ends of the hooks 62 protruded inward from the outer frame 60 are externally engaged with the through holes 59b of the both elastic pieces 59a of the outer blade frame 59 (see FIG. 5). The outer blade frame 59, or the outer frame cassette 50 is thus attached to the outer frame 60.

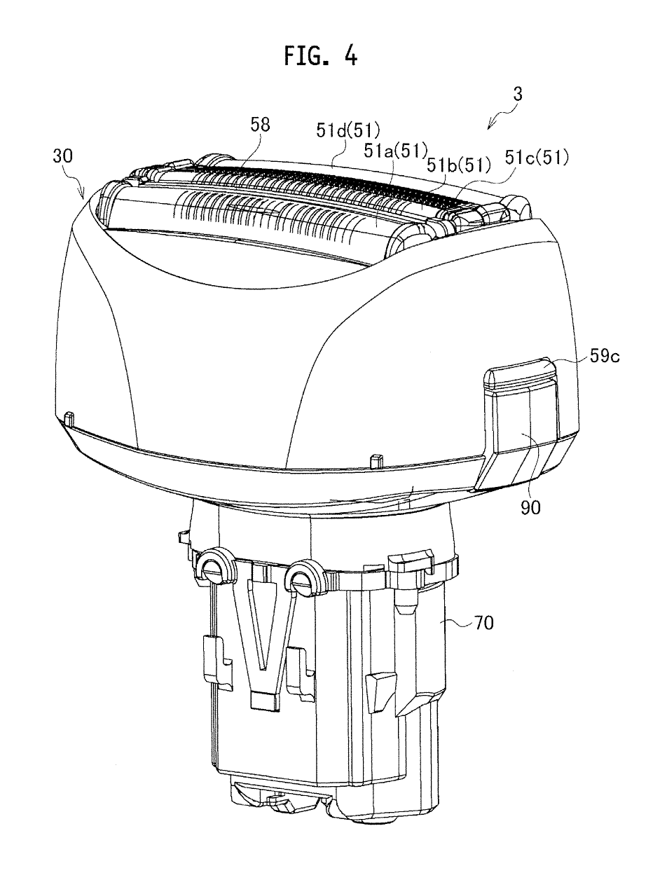

As shown in FIGS. 4 and 5, the release buttons 59c of the outer blade frame 59 are provided so that the top ends thereof protrude outward from the respective outer side surfaces of the outer frame 60 when the outer frame 60 is attached. Accordingly, if operation faces 59d at the top ends of the right and left release buttons 59c are grasped and sandwiched to be depressed inside, the elastic pieces 59a at both sides bend inward to release the engagement of the hooks 62 and through-holes 59b, and the outer blade cassette 50 is thus detached from the outer frame 60.

As shown in FIG. 5, at both right and left ends of the head section body 70, release buttons 90 are provided so as to protrude and retract while being energized outward in the right-left direction Y. At both ends of the top part of each release button 90 in the width direction (front-back direction X), engagement protrusions 90a are provided (see FIG. 2).

If the blade frame unit 30 is placed over the head section body 70 while the release buttons 90 are inserted through the recessed portions 61 of the outer frame 60 at the both right and left ends, the engagement protrusions 90a energized outward in the right-left direction Y are engaged with not-shown engagement recesses formed in the inner periphery of the outer blade frame 59. The outer blade frame 90 (the outer blade cassette 50 or the entire blade flame unit 30) is thus attached to the upper end of the head section body 70.

If the release buttons 90 are depressed inside against the energization force of the springs 91, the engagement of the engagement protrusions 90a and engagement recesses (not shown) is released, and the outer blade frame 59 is then detached from the head section body 70.

Next, the driving mechanism 100 is described.

In this embodiment, as shown in FIG. 2, the driving mechanism 100 includes: a rotary motor 110; a support 120 supporting the rotary motor 110; the first and second driving elements 130 and 140 which are supported on the support 120 and reciprocate in opposite phases; and a conversion mechanism 180 converting rotating motion of the rotary motor 110 to reciprocating motion and transmitting the reciprocating motion to the first and second driving elements 130 and 140.

The rotary motor 110 is attached to the support 120 so as to hang downward. The support 120 includes: a bottom wall 121; and fixed side walls 122 integrally stood from right and left edges of the bottom wall 121. In each fixed side wall 122, a threaded hole 122a is formed. Fixing screws 190 are screwed into the treaded holes 122a to fix the support 120 to the head case 71 together with the first and second driving elements 130 and 140.

The conversion mechanism 180 includes: a base 181 rotatably attached to a rotating shaft 111 of the rotary motor 110 protruded from the bottom wall 121 of the support 120; and a lower eccentric shaft 182 provided eccentrically away from the rotating shaft 111. The conversion mechanism 180 further includes: a lower coupling arm 183 which is attached to the lower eccentric shaft 182 and couples the lower eccentric shaft 182 and the second driving element 140; and a base 184 attached to the lower eccentric shaft 182. The conversion mechanism 180 further includes: an upper eccentric shaft 185 provided for the base 184 eccentrically away from the rotating shaft 111; and an upper coupling arm 186 which is attached to the upper eccentric shaft 185 and couples the upper eccentric shaft 185 and the first driving element 130.

In this embodiment, the upper and lower eccentric shafts 182 and 185 are provided with a phase difference of 180 degrees around the rotating shaft 111 of the rotary motor 110 and converts rotating motion of the rotary motor 110 to reciprocating motion of the first and second driving elements 130 and 140 in opposite phases.

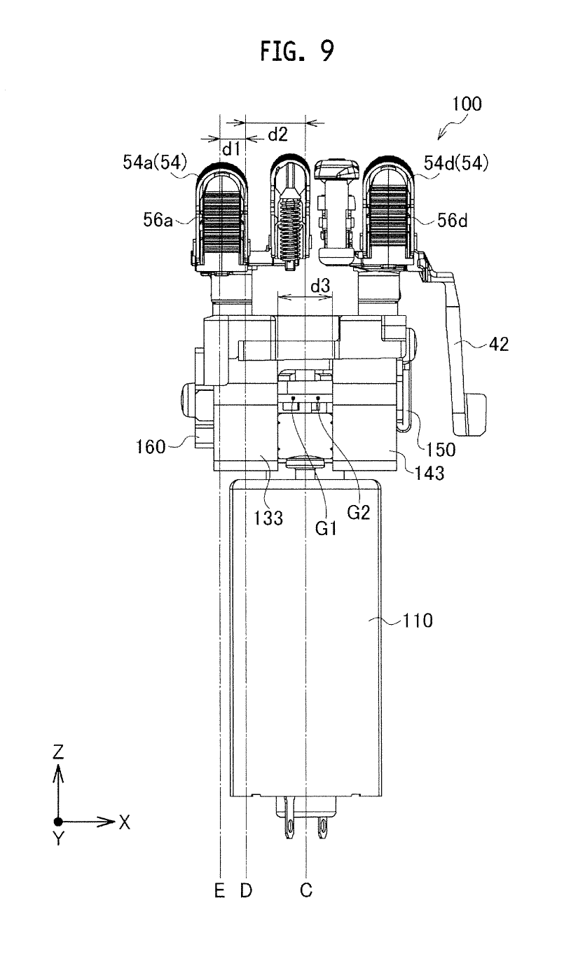

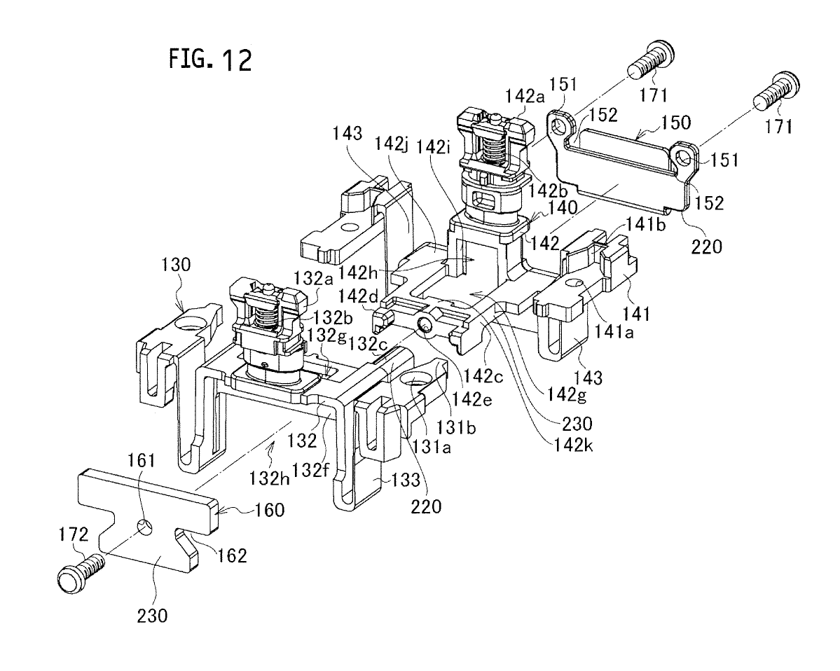

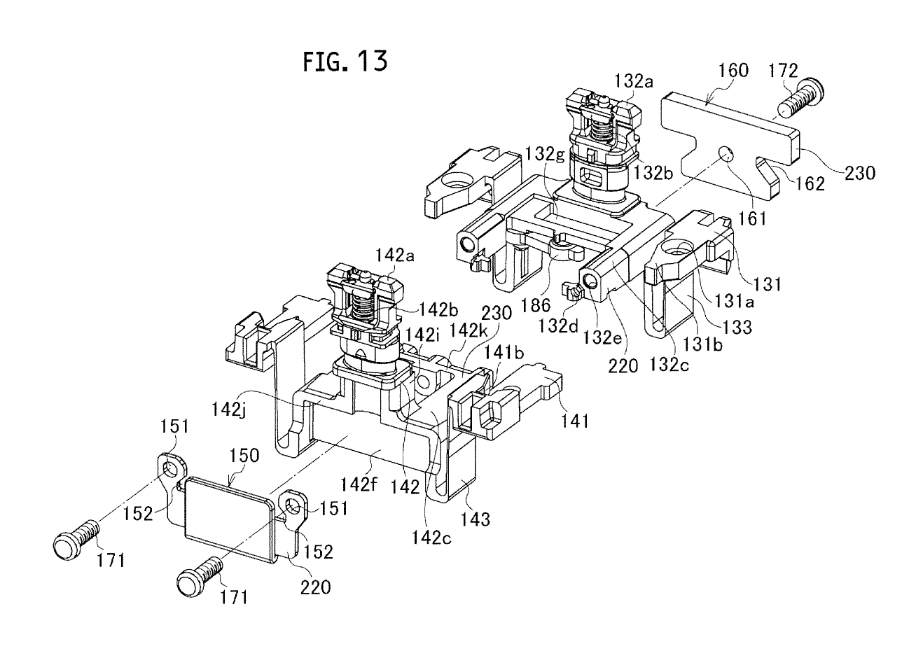

As described above, the first and second driving elements 130 and 140 include the inner blade attachment portions 132a and 142a to which the inner blades 54a and 54d are detachably attached, respectively. As shown in FIGS. 12 and 13, the first driving element 130 is formed by connecting fixing blocks 131, which are arranged at both ends in the width direction, to the support frame 132, which supports the inner blade attachment portion 132a, with a pair of elastically deformable elastic legs (elastic legs supporting the inner blade attachment portions 132a so as to reciprocate) 133. The second driving element 140 is formed by connecting fixing portions 141, which are arranged at both ends in the width direction, to the support frame 142, which supports the inner blade attachment portion 142a, with a pair of elastically deformable elastic legs (elastic legs supporting the inner blade attachment portions 142a so as to reciprocate) 143. The elastic legs 133 and 143 are arranged under the inner blade attachment portions 132a and 142a, respectively, when viewed in the right-left direction (the direction of reciprocation of the driving elements) Y (see FIG. 9).

The fixing blocks 131 and 141 are respectively provided with threaded holes 131a and 141a and engagement portions engaged with each other (engagement protrusions 131b and 141b in this embodiment). When the fixing block 131 is placed on the fixing block 141 with the engagement protrusions 131b and 141b engaged with each other, the threaded holes 131a and 141a communicate with each other. The screws 190 are inserted into the threaded holes 131a and 141a communicating with each other to fix the first and second driving elements 130 and 140 to the head case 71 with the support 120 interposed therebetween.

The support frames 132 and 142 each have a rectangular plate shape substantially horizontally extending, and on the support frames 132 and 142, the inner blade attachment portions 132a and 142a are protruded, respectively. At both ends of the support frame 142 in the width direction, side walls 142i are extended downward, and at the lower end of each side wall 142i, a horizontal wall 142j is extended outward in the width direction (see FIG. 12).

Each of the elastic legs 133 has a folded sheet-like shape. An end thereof is connected to the upper inner end of the corresponding fixing block 131, and the other end is connected to one of the outer ends of the support frame 132. On the other hand, each of the elastic legs 143 has a folded sheet-like shape. An end thereof is connected to the upper inner end of the corresponding fixing block 141, and the other end is connected to one of the outer ends of the horizontal wall 142j. In other words, the elastic leg 143 connects the fixing block 141 and the support frame 142 with the horizontal wall 142j and side wall 142i interposed therebetween.

The inner blade attachment portions 132a and 142a are provided with lifting springs (energizing members) 132b and 142b, respectively. The lifting springs 132b and 142b press (energize) up the inner blades 54a and 54d attached to the inner blade attachment portions 132a and 142a (in the direction of attachment or detachment of the inner blades), respectively.

In this embodiment, the outer part of each of the elastic legs 133 and 143 is thinner than the inner part thereof. By making the outer parts of the elastic legs 133 and 143 thinner, the support frames 132 and 142 (including the inner blade attachment portions 132a and 142a and the inner blades 54) can be easily swung in the right-left direction Y. Moreover, by making thick the inner parts which are subject to reaction force from the inner blades 54a and 54d energized upward, it can be prevented that the first and second driving elements 130 and 140 are deformed by the reaction force due to the inner blades 54a and 54d.

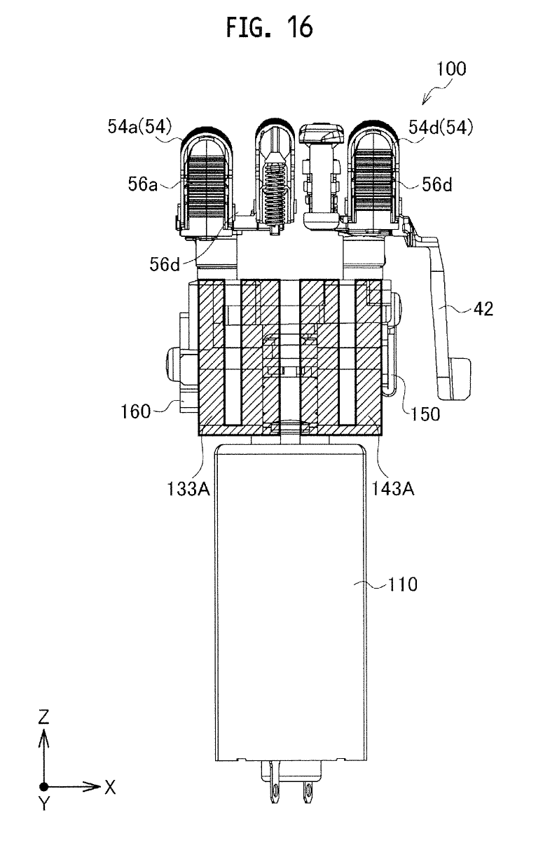

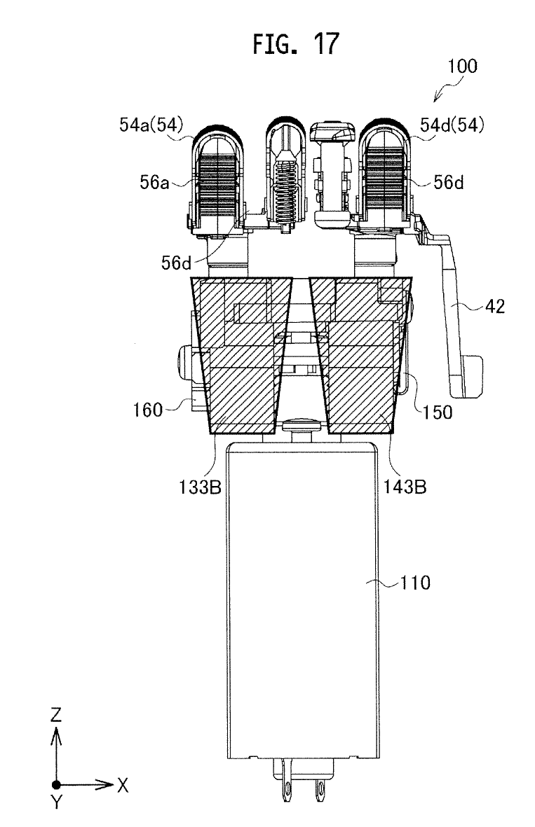

The elastic legs 133 and 143 can be formed as shown in FIGS. 16 and 17. Specifically, as shown in FIG. 16, a plurality of elastic plates are arranged side by side in the front-back direction X to form each elastic leg 133A or 143A. At this time, if the elastic plates are not provided for portions less influenced by rotational moment in the front-back direction X, the elastic legs 133A and 143A can be easily deformed while the elastic legs 133A and 143A are increased in width to increase in rigidity. In other words, the support frames 132 and 142 can be easily reciprocated.

The description is made more in detail. In order to resist tensile force produced in the elastic legs 133A and 143A, it is desirable to widen widths (widths in the X direction) of the elastic legs 133A and 143A. However, if the widths are widened as described above, then force required to deform the elastic legs 133A and 143A also becomes large, and this brings about the increase of the load, and accordingly, such a malfunction that an operating time is shortened occurs in a rechargeable shaver. The malfunction occurs more significantly in the case of thickening thicknesses (thicknesses in the Y direction) of the elastic legs 133A and 143A. Accordingly, in this embodiment, such portions less affected by the tensile force by the rotation moments in the front-back direction X are cut away, or such portions largely affected by the tensile force are thickened.

Moreover, as shown in FIG. 17, elastic legs 133B and 143B can also be formed so as to have a tapered profile in which each of upper portions (inner blade sides) thereof is wide. In such a way, rigidity of the upper portions largely affected by the rotation moments in the front-back direction X can be increased while suppressing, to the maximum, a phenomenon that the elastic legs 133A and 143A become less likely to be deformed. As a matter of course, the upper portions just need to be formed so as to be wide, and a shape thereof is not limited to the tapered profile.

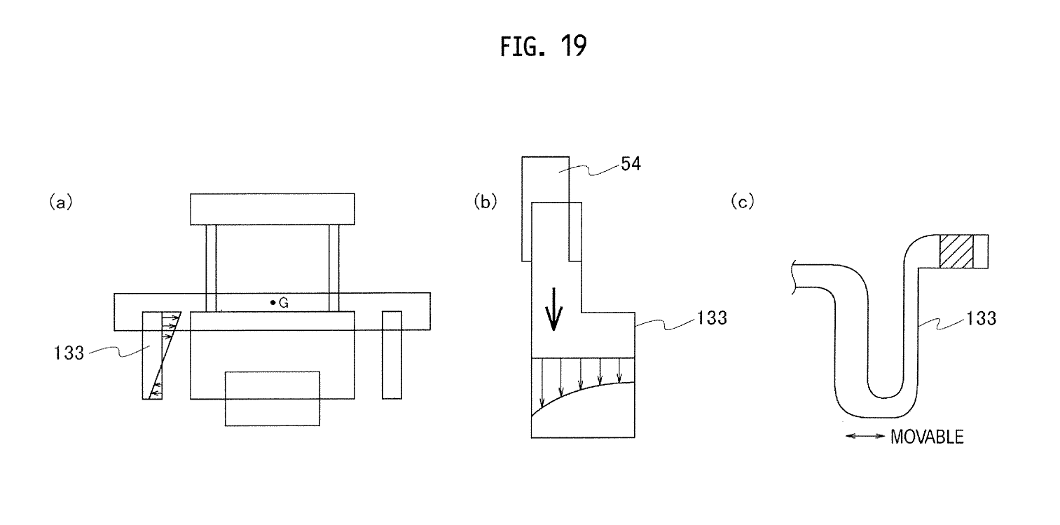

FIG. 19 is schematic views for explaining the influence by such a rotation moment in the front-back direction X. For example, as shown in FIG. 19(a), in the case of viewing the elastic leg 133 in the Z direction, when a gravity center G of a driving block (to be described later) in the X direction deviates from a centerline of the elastic leg 133 in the X direction, then force to twist the elastic leg 133 is applied, and a twist stress is increased more in an end thereof. Meanwhile, as shown in FIG. 19(b), in the case of viewing the elastic leg 133 in the Y direction, the reaction force to press the inner blade is not applied uniformly, and a tensile stress is increased more in an end on the line-of-action side of the reaction force to press the inner blade.

Hence, it is effective to cut away a central portion of the leg in which the twist stress is low, and to widen the leg toward the above for the purpose of widening the width of the leg in the front-back direction X. The reason for widening the upper side of the leg is that flexibility of the upper side is small since the upper side is closer to a fixed side (hatched portion in FIG. 19(c)) of the leg, and is prone to cause a fracture in the event of being applied with impact force.

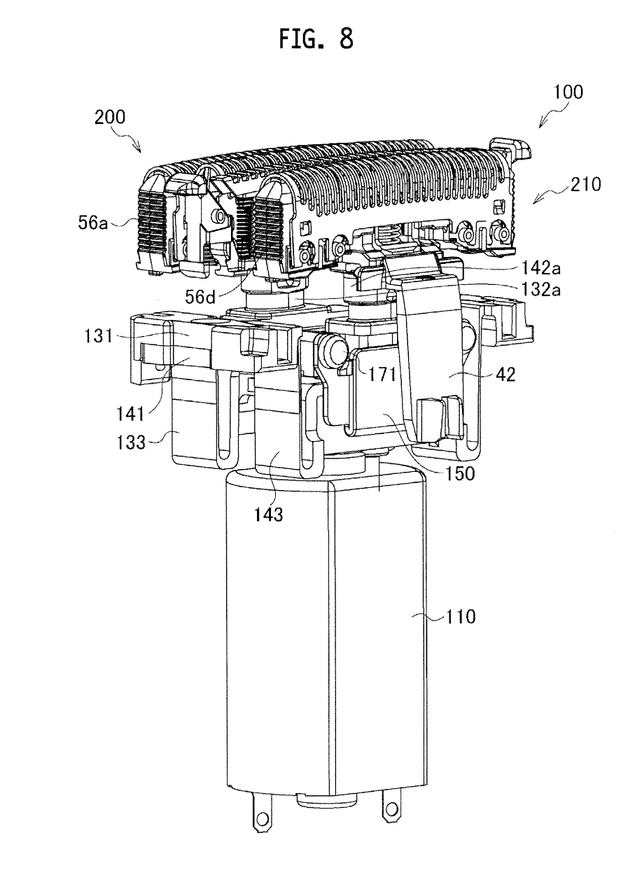

Furthermore, in this embodiment, a driving rod 42 driving the trimmer blade 41a (see FIGS. 8 and 9) is attached to the inner blade attachment portion 142a. As descried above, the inner blade attachment portions 132a and 142a are coupled with the driving rods 134 and 144, respectively.

The first driving element 130 reciprocates the inner blade 54a and the finishing inner blade 54b attached to the driving rod 134 together, and the second driving element 140 reciprocates the inner blade 54a, the inner slit blade 54c attached to the driving rod 144, and the driving rod 42 together.

In this embodiment, the inner blade (including the base 56a) 54a, driving rod 134, finishing inner blade (including the base 56b) 54b, and a later-described balance adjuster 150 serve as a coupling member which is coupled with the first driving element 130 to operate in conjunction with the first driving element 130 reciprocating. The coupling member and first driving element 130 constitute a first driving block 200.

On the other hand, the inner blade (including the base 56d) 54d, inner slit blade (including the base 56c) 54c, driving rod 144, driving rod 42, and a later-described balance adjuster 160 serve as a coupling member which is coupled with the second driving element 140 to work in conjunction with the second driving element 140 reciprocating. The coupling member and second driving element 140 constitute a second driving block 210.

In this embodiment, the inner blades 54 are arranged two by two at the front and rear sides of a rotation axis C of the rotary motor 110, and the front two inner blades are reciprocated in the phase opposite to the rear two inner blades. By reciprocating the first and second driving elements 130 and 140 in opposite phases in such a manner, vibration due to inertia force in the direction of reciprocation (moment produced about the X axis) is reduced.

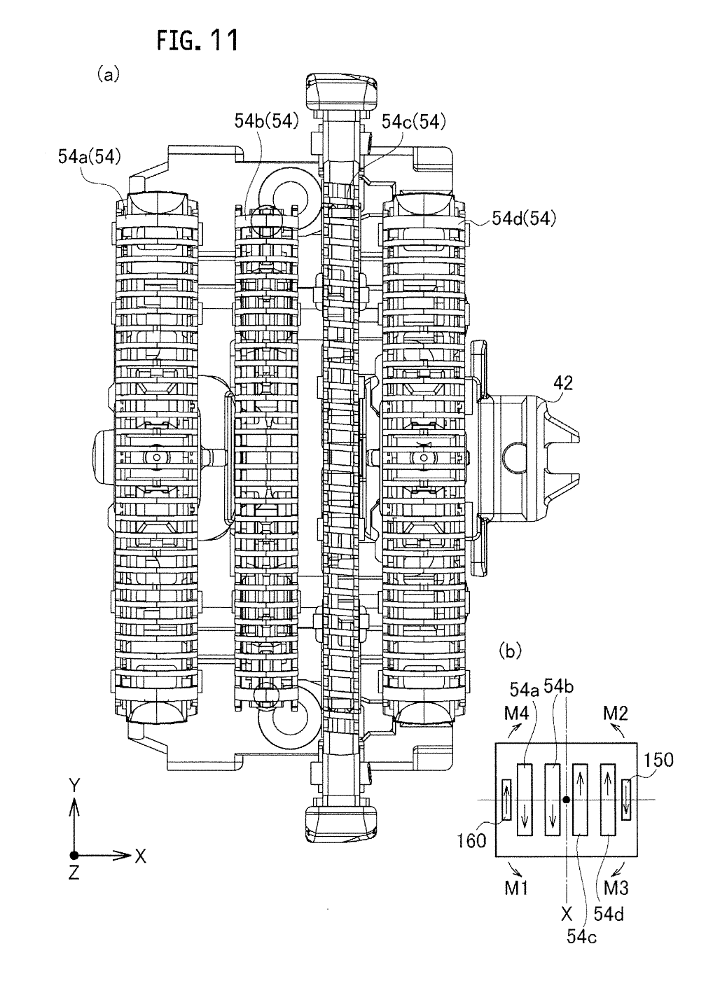

Such reciprocating motions in opposite phases can reduce the moment about the X axis but produces moments (M1 and M2 in FIG. 11(b)) about the rotation axis C of the rotary motor 110 in the same direction (clockwise in FIG. 11(b)).

Accordingly, in this embodiment, the first and second driving blocks 200 and 210 are configured to include balance adjustment portions 220 and 230 placed on the opposite sides of the rotation axis C of the rotary motor 110 from the first and second driving elements 130 and 140, respectively.

Specifically, the balance adjusters 150 and 160 are attached to the first and second driving elements 130 and 140 with holding arms 132c and 142c interposed therebetween, respectively.

By attaching the balance adjusters 150 and 160 to the first and second driving elements 130 and 140 as described above, gravity centers G1 and G2 of the first and second driving blocks 200 and 201 can be set closer to the rotation axis C of the rotary motor 110 than in the absence of the balance adjusters 150 and 160, thus reducing vibration about the rotation axis C. Furthermore, when the first and second driving blocks 200 and 210 are reciprocated in opposite phases in the state where the balance adjusters 150 and 160 are attached to the first and second driving elements 130 and 140, moments about the rotation axis C are produced at the first and second driving elements 130 and 140 so as to be opposite to the moments M1 and M2 (M3 and M4 in FIG. 11(b)), respectively. In short, the moments M1 and M3 are canceled out, and the moments M2 and M4 are canceled out. Accordingly, the vibration about the rotation axis C can be reduced.

The balance adjusters 150 and 160 are formed separately from the first and second driving elements 130 and 140, respectively.

In this embodiment, the balance adjustment portions 220 and 230 are provided so that the gravity centers G1 and G2 of the first and second driving blocks 200 and 210 are located between the elastic legs 133 and 143 (in a range indicated by d3 in FIG. 9) when viewed in the right-left direction (in the direction of reciprocation of the driving elements) Y.

In such a manner, the gravity centers G1 and G2 of the first and second driving blocks 200 and 201 can be therefore set closer to the rotation axis C of the rotary motor 110. This can reduce the moment to be produced about the rotation axis C of the rotary motor 110 at driving, thus reducing the vibration.

If the first and second driving blocks 200 and 210 are designed in particular so that the gravity centers G1 and G2 thereof correspond to the rotation axis C of the rotary motor 110, respectively, the moment about the rotation axis C of the rotary motor 110 can be made zero, and the occurrence of vibration can be further reduced.

In this embodiment, the balance adjuster 150 is attached to holding arms (arm portions) 132c which are horizontally extended from both ends of the support frame 132 in the width direction (right-left direction Y) toward the opposed second driving element 140 (backward in the front-back direction).

On the other hand, the balance adjuster 160 is attached to holding arms (arm portions) 142c which are horizontally extended from both ends of the horizontal wall 142j of the support frame 142 in the width direction (right-left direction Y) toward the opposed first driving element 130 (forward in the front-back direction).

In such a manner, the holding arms (arm portions) 132c extended from the first driving element 130 and the holding arms (arm portions) 142c extended from the second driving element 140 are located at different positions in the up-down direction Z (direction orthogonal to the direction X that the first and second driving elements 130 and 140 are arranged and the direction Y of reciprocation thereof). In this embodiment, the holding arms (arm portions) 132c and 142c are extended in the front-back direction X at different heights in the up-down direction. By arranging the holding arms (holding portions) 132c and 142c at different heights in the up-down direction in such a manner, the first and second driving blocks 200 and 210 are miniaturized.

In this embodiment, furthermore, the holding arms (arm portions) 142c out of the holding arms (arm portions) 132c and 142c are configured to sit above the conversion mechanism 180 in the up-down direction Z. By allowing at least one of the pair of holding arms (arms portions) 132c and the pair of holding arms 142c to sit above the conversion mechanism 180 in the up-down direction Z in such a manner, the first and second driving blocks 200 and 210 can be further miniaturized (in the height direction).

The holding arms (arm portions) 132c and the holding arms (arm portions) 142c serve as the balance adjustment portions 220 and 230 by themselves, respectively. In this embodiment, the balance adjustment portions 220 and 230 include the holding arms 132c and 142c extending from the first and second driving elements 130 and 140 toward the opposite sides across the rotation axis C of the rotary motor 110 from the first and second driving elements 130 and 140, respectively.

Accordingly, if the first and second driving elements 130 and 140 are not provided with the balance adjusters 150 and 160 but provided with the holding arms 132c and 142c, respectively, the gravity centers G1 and G2 of the first and second driving blocks 200 and 210 can be set closer to the rotation axis C of the rotary motor 110 than in the absence of the balance adjustment portions 220 and 230. In other words, the occurrence of vibration can be reduced even without the balance adjusters 150 and 160 by properly setting the lengths and weights of the holding arms 132c and 142c.

At the end faces of the holding arms 132c of the first driving element 130, threaded holes 132e are formed, and in the balance adjuster 150, attachment holes 151 are formed at the positions corresponding to the threaded holes 132e. The threaded holes 132e of the first driving element 130 are caused to communicate with the attachment holes of the balance adjuster 150, and screws 171 are then screwed into the threaded holes 132e of the first driving element 130, thus fixing the balance adjuster 150 to the first driving element 130. In short, the balance adjuster 150 is attached to the first driving element 130 from the front in the arrangement direction X of the first and second driving elements 130 and 140.

At the front end of the holding arm 142c of the second driving element 140, a connecting arm 142k connecting the holding arms 142 is provided to extend in the right-left direction Y. At the center of the coupling arm 142k in the width direction, a threaded hole 142e is provided. At the position corresponding to the threaded hole 142e in the balance adjuster 160, an attachment hole 161 is formed. The threaded hole 142e of the second driving element 140 is caused to communicate with the attachment hole 161, and a screw 172 is then screwed into the threaded hole 142e, thus fixing and retaining the balance adjuster 160 onto the second driving element 140.

Since the balance adjuster 160 is attached to the second driving element 140 from behind the first driving element 130 (from the front side in the front-back direction X) and the balance adjuster 150 is attached to the first driving element 130 from behind the second driving element 140 (from the rear in the front-back direction X), the balance adjusters 150 and 160 can be attached after the first and second driving elements 130 and 140 and the rotary motor 110 are assembled. Accordingly, this can facilitate the attachment of the balance adjusters 150 and 160.

The balance adjusters 150 and 160 are provided at the outermost portions of the driving elements 130 and 140 (at both ends in the front-rear direction X), respectively. In this embodiment, as shown in FIG. 9, the balance adjusters 150 and 160 are provided for the first and second driving elements (one of the elements) 130 and 140 so as to at least partially protrude from the second and first driving elements (the other element) 140 and 130 on the opposite sides to the first and second driving elements (the one element) 130 and 140, respectively. It is therefore possible to maximize the distance between the balance adjusters 150 and 160 (distance between the rotation axis C and each gravity center) while preventing the first and second driving blocks 200 and 210 from increasing in size. Accordingly, the balance adjusters 150 and 160 can be reduced in weight. Moreover, since the balance adjusters 150 and 160 can be reduced in weight, the balance adjusters 150 and 160 can be further miniaturized. This can further prevent the first and second driving blocks 200 and 210 from increasing in size.

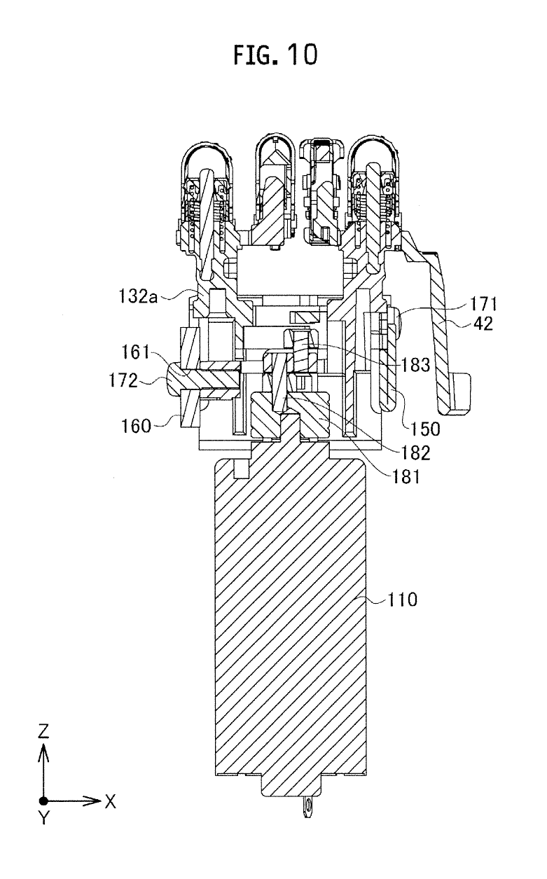

As shown in FIG. 10, the balance adjusters 150 and 160 are partially placed inside the outermost portions of the driving elements 130 and 140 (the both ends in the front-back direction X). This prevents the balance adjusters 150 and 160 from greatly protruding outward from the first and second driving elements 130 and 140. Furthermore, by arranging only the balance adjusters 150 and 160 slightly inside the first and second driving elements 130 and 140, it can be prevented that the positions of the points of action (gravity centers) of the balance adjusters 150 and 160 are shifted to the inside.

Since the balance adjusters 150 and 160 are located at the outermost portions of the driving elements 130 and 140, the balance adjusters 150 and 160 can be attached without any restriction due to the shapes of the first and second driving elements 130 and 140. It is therefore possible to increase the flexibility in the shapes of the first and second driving elements 130 and 140.

Furthermore, in this embodiment, the balance adjusters 150 and 160 have different shapes so as to have the gravity centers at the positions optimal to the first and second driving blocks 200 and 210.

To be specific, the balance adjuster 150 is formed by folding a substantially Y-shaped plate member, and the aforementioned attachment holes 151 are formed at both ends of upper part in the width direction.

On the other hand, the balance adjuster 160 is a plate member having a substantially T-shaped front profile, and the aforementioned attachment hole 161 is formed at the substantially center.

By providing the attachment holes 151 and the attachment hole 161 at different height positions, the balance adjusters 150 and 160 are located at a substantially same height position when attached to the first and second driving elements 130 and 140, so that the first and second driving blocks 200 and 210 can be miniaturized.

In this embodiment, the balance adjusters 150 and 160 are attached to the first and second driving elements 130 and 140 so that the thickness directions of the plate-shaped balance adjusters 150 and 160 match the front-rear direction X, respectively. It is therefore possible to maximize the distance between the points of action of the balance adjusters 150 and 160 (distance between each gravity center and the rotation axis C) while preventing an increase in dimension in the front-rear direction X, thus miniaturizing the first and second blocks 200 and 210.

Furthermore, in this embodiment, notches 152 are formed at both right and left sides of the balance adjuster 150, and notches 162 are formed at both right and left sides of the balance adjuster 160.

On the other hand, protrusions 132d are formed in the holding arms 132c of the first driving element 130 and are configured to be engaged with the notches 152 of the balance adjuster 150. Moreover, protrusions 142d are formed in the holding arms 142c of the second driving element 140 and are configured to be engaged with the notches 162 of the balance adjuster 160. These engagements allow the balance adjusters 150 and 160 to be respectively positioned and fixed to the driving elements 130 and 140 so as not to move up, down, right, and left.

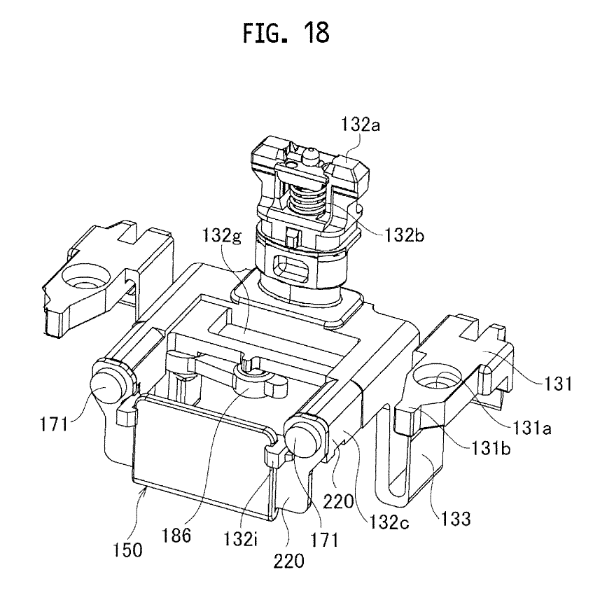

As shown in FIG. 18, the holding arms 132c may be provided with hooks 132i instead of the protrusions 132d so that the balance adjuster 150 is engaged with the hooks 132i. Alternatively, the balance adjusters may be attached to the driving elements with heat seal. Moreover, it is possible to provide holes instead of the notches so that the protrusions of the holding arms are engaged with the holes.

In this embodiment, the balance adjustment portions 220 and 230 provided for the first and second driving elements (one driving element) 130 and 140 are arranged so that the holding arms 132c and 142c and the balance adjusters 150 and 160 (at least a part of each of the balance adjustment portions 220 and 230) are slightly sit in spaces formed in the second and first driving elements (the other element) 140 and 130, respectively. This prevents the holding arms 132c and 142c from interfering with the driving elements 140 and 130 facing the same and prevents the pair of driving elements 130 and 140 from increasing in size, respectively.

Specifically, the first and second driving elements 130 and 140 are assembled to each other in such a way that the holding arms 132c of the first driving element 130 pass through shoulder spaces of the second driving element 140 (above the horizontal wall 142j) and the holding arms 142c of the second driving element 140 pass through space under the first driving element 130 (space between the pair of elastic legs 133: corresponding to a later described window 132h in this embodiment).

Furthermore, in this embodiment, the window 132h which allows the conversion mechanism 180 to be visible is provided.

Specifically, the pair of elastic legs 133 and the support frame 132 of the first driving element 130 are formed in a gate shape to provide the window 132h surrounded by the pair of elastic legs 133 and support frame 132 on three sides, thus allowing the inside (conversion mechanism 180) to be visible in the front-back direction X. Providing the window 132h in such a manner facilitates the work to assemble the driving blocks and the work to check the joint of the conversion mechanism 180.

Still furthermore, in this embodiment, the first driving element 130 is provided with a window 132g. The window 132g is composed of the support frame 132 and holding arms 132c to allow the inside (conversion mechanism 180) to be visible in the up-down direction Z. Moreover, the second driving element 140 is provided with a window 142g which is composed of the holding arms 142c and connecting arm 142k and allows the inside (conversion mechanism 180) to be visible in the up-down direction Z. By allowing the inside (conversion mechanism 180) to be visible in the up-down direction Z, the assembling and checking works are further facilitated.

In this embodiment, the balance adjusters 150 and 160 are made of metal (a material denser than the first and second driving elements 130 and 140). The balance adjusters 150 and 160 can be therefore miniaturized, and the head section 3 can be miniaturized as a whole. In this embodiment, as described above, the balance adjusters 150 and 160 are provided in a water-proof space (sealed space) 80 sealed so as to prevent body hair cut by the inner blades 54 or water used to wash the inner blades 54 from entering. This can prevent the balance adjusters 150 and 160 made of metal from rusting.

Here, in this embodiment, the elastic legs 133 and 143 are arranged so that, in a state of being viewed in the left-right direction (reciprocating direction of the driving elements) Y, central portions of the elastic legs 133 and 143 in the front-back direction X (an intermediate line in the direction orthogonal to the reciprocating direction and to the attachment direction: a centerline D shown in FIG. 9) can be located between the rotation axis C of the rotary motor 110 and a line E of action of reaction force produced by the lifting springs (urging members) 132b and 142b. Therefore, stresses in the twisting direction, which are generated in the elastic legs 133 and 143, are reduced, and the increase of the load to the elastic legs 133 and 143 can be suppressed.

Specifically, the elastic legs 133 and 134 are placed so that the central portions of the elastic legs 133 and 143 in the front-back direction X is closer to a line E of action of reaction force produced by the lifting springs (energization members) 132b and 142b than to the rotation axis C of the rotary motor 110 (d1<d2). Providing the elastic legs 133 and 143 closer to the line E of action of the reaction force due to the lifting springs 132b and 142b in such a manner can reduce the moments about the Y axis produced at the elastic legs 133 and 143 by the reaction force due to the lifting springs 132b and 142b, respectively. The elastic legs 133 and 143 are therefore prevented from being broken by stress concentration. When the elastic legs 133 and 143 are provided away from the rotation axis C of the rotary motor 110, the moments about the rotation axis C produced at the elastic legs 133 and 143 increase. In this embodiment, however, the reaction forces due to the lifting springs 132b and 142b are large, and setting d1<d2 can reduce the influence of vibration on the whole apparatus.

In the driving elements 130 and 140, walls 132f and 142f for reinforcement are formed, respectively. In this embodiment, the wall 132f is formed inside the line E of action of the reaction force due to the lifting spring 132b (rearward of the line E of action in the front-back direction X). The wall 142f is formed inside the line E of action of the reaction force due to the lifting spring 142b (forward of the line E of action in the front-back direction X).

The reason why the walls 132f and 142f are formed inside the line E of action as described above is that the walls 132f and 142f also have masses. Specifically, by forming the walls 132f and 142f inside the lines E of action of reaction forces due to the lifting springs 132b and 142b in such a manner, it is possible to reduce the influence of the moment about the Y axis due to the walls 132f and 142f while preventing the driving elements 130 and 140 from being deformed by the reaction forces due to the lifting springs 132b and 142b.

The wall 132f is shorter than the elastic legs 133 so as not to block the window 132h. The window 132h is closed by attaching the balance adjuster 160. This can prevent that sound produced by the driving elements leaks out.

As described above, in this embodiment, the first and second driving blocks 200 and 210 are configured to include the balance adjustment portions 220 and 230 arranged on the opposite sides of the rotation axis C of the rotary motor 110 from the first and second driving elements 130 and 140, respectively.

Accordingly, the gravity centers G1 and G2 of the first and second driving blocks 200 and 210 can be set closer to the rotation line C of the rotary motor 110 than in the absence of the balance adjustment portions 220 and 230. In other words, it is possible to shorten the distance between the rotation axis C of the rotary motor 110 and the gravity center of each driving block and therefore reduce the moment about the rotation axis C at each driving element. This can reduce the vibration of the reciprocating electric shaver 1 including a plurality of driving elements arranged side by side.

Hereinabove, the preferred embodiment of the present invention is described. However, the present invention is not limited to the aforementioned embodiment, and various modifications thereof can be made.

### INDUSTRIAL APPLICABILITY

In accordance with the present invention, the reciprocating electric shaver can be obtained, which is capable of suppressing the increase of the load to the elastic legs.

1. A reciprocating electric shaver, comprising:
a rotary motor;
a conversion mechanism converting rotating motion of the rotary motor to reciprocating motion; and
a pair of driving elements coupled to the conversion mechanism and reciprocating in phases opposite to each other,
wherein each of the driving elements drives a plurality of blades,
in each of the driving elements, an inner blade attachment portion to which an inner blade is detachably attached is formed, and moreover, an elastic leg supporting the inner blade attachment portion to allow the same to reciprocate is formed,
an urging member urging the inner blade in a detaching direction of the inner blade is provided in each inner blade attachment portion, and
in a case of being viewed in a reciprocating direction of the driving elements, an intermediate line of the elastic leg in a direction orthogonal to the reciprocating direction and the detaching direction is located between a rotation axis of the rotary motor and a line of action of reaction force produced by the urging member.

2. The reciprocating electric shaver according to claim 1, wherein the intermediate line of the elastic leg in the direction orthogonal to the reciprocating direction and the detaching direction is located closer to the line of action than to the rotation axis of the rotary motor.

3. The reciprocating electric shaver according to claim 1,
wherein walls for reinforcement are formed in the driving elements, and
the walls are formed inside the line of action.

4. The reciprocating electric shaver according to claim 1,
wherein the elastic leg is formed by arranging a plurality of elastic plates side by side.

5. The reciprocating electric shaver according to claim 1,
wherein the elastic leg is formed so that an inner blade side thereof can be wide.
